(19) United States
(12) Patent Application Publication
(10) Pub. No.: US 2004/0226204 A1
(43) Pub. Date: Nov. 18, 2004

(54) Changeable sign on a rear of a vehicle

(76) Inventor: Randy Green, Naples, FL (US)

Correspondence Address: Randy Green, 1200 Misty Pines Circle #201, Naples, FL, 34105, US

(21) Appl. No.: 10/434,732

(22) Filed: May 12, 2003

(51) Int. Cl. G09F 21/04

(52) U.S. Cl. 40/591; 40/590; 40/446

(57) ABSTRACT

The invention is directed to an electronic message unit that is mounted at the rear of a vehicle that will display messages directed to a driver behind the vehicle. The messages displayed on the message unit are controlled by the driver of the vehicle in front.

### CROSS REFERENCE TO RELATED APPLICATIONS

(none

### STATEMENT REGARDING FED SPONSORED R & D

(none)

### BACKGROUND OF THE INVENTION

The invention is directed to changeable signs that are displayed at or on the rear of a vehicle. It has occurred many times to a driver of a first vehicle to send a message to a driver of a second vehicle following the first vehicle indicating certain conditions that are ahead and the driver of the second vehicle may not be aware of. Such messages may be “congestion ahead” or “construction is ahead” or “Traffic is stopping”. The changeable sign may also display a message such as “you are following too closely, please back off”. The sign may also state “your right rear door is ajar”. Or it may display: “your left rear tire is low of air”. Of course there are many messages available depending on traffic conditions.

### BRIEF SUMMARY AND OBJECTS OF THE INVENTION

It is an object of the invention to arrange for a sign to be placed on the rear of a vehicle to send a message to a second driver following the first driver of traffic conditions ahead that may not be observed by the second driver. The sign may not only display the traffic conditions ahead but other messages relative to safety: like: “You are following too closely” or “please dim your headlights”.

The sign displaying the message may be mounted on the rear of vehicles such as a passenger car, a van, a pick-up truck, a stake truck or semi-truck. The various ways of mounting the sign will be explained below.

### BRIEF DESCRIPTION OF THE DRAWINGS

FIG. 1 shows the invention on a semi-truck with the sign on the back;

FIG. 2 shows the sign of the invention with the sign on the interior or exterior of the back window;

FIG. 3 shows the sign of the invention on a passenger car mounted on a spoiler;

FIG. 4 illustrates the rear sign mounted on the rear of a stake truck;

FIG. 5 shows the rear sign mounted on a spoiler in detail.

### DETAILED DESCRIPTION OF THE INVENTION

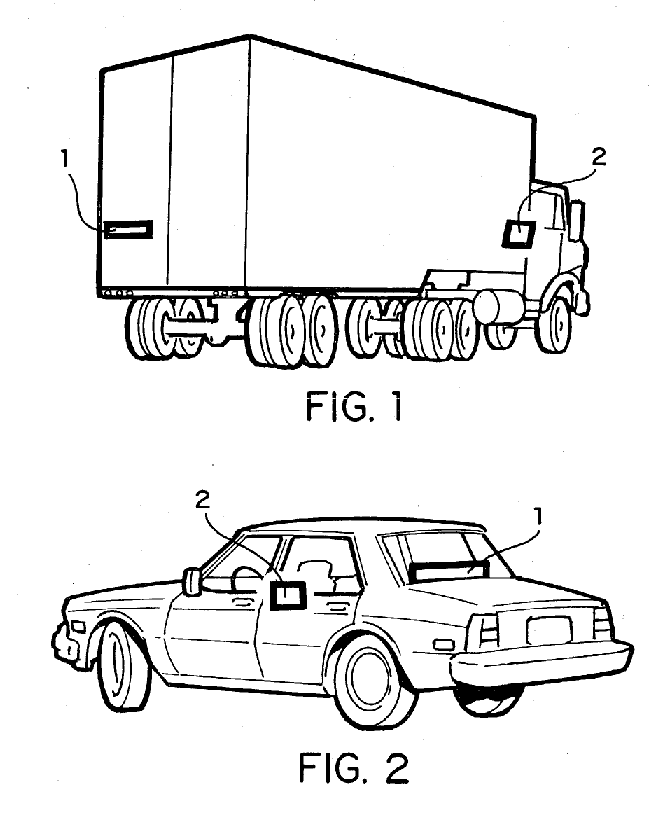

FIG. 1 illustrates the invention as it is mounted and displayed on a semi-truck. The display or message unit 1 is mounted at the rear of the truck. It could display a message such as “If you cannot see my mirrors, I cannot see you”. The sending unit 2 is mounted up front in the cab and is readily available to the driver to send different messages as the situation requires. Both the message unit 1 and the sending unit 2 are well known and distributed under the Beta Brite™ registered Trade Mark and it is distributed as a “one-line electronic sign”. This system is mostly used as an in-store advertising module to advertise special items or one-day specials. So the question at hand is this system “a new use of a known item”? The answer to this Question must be a resounding “yes” unless electronic changeable signs have been displayed on or at a rear of a vehicle before.

FIG. 2 shows the same display unit 1 mounted in the rear window, that is, either exterior or interior. the sending unit 2 is up front with the driver either built in or on the passenger side seat.

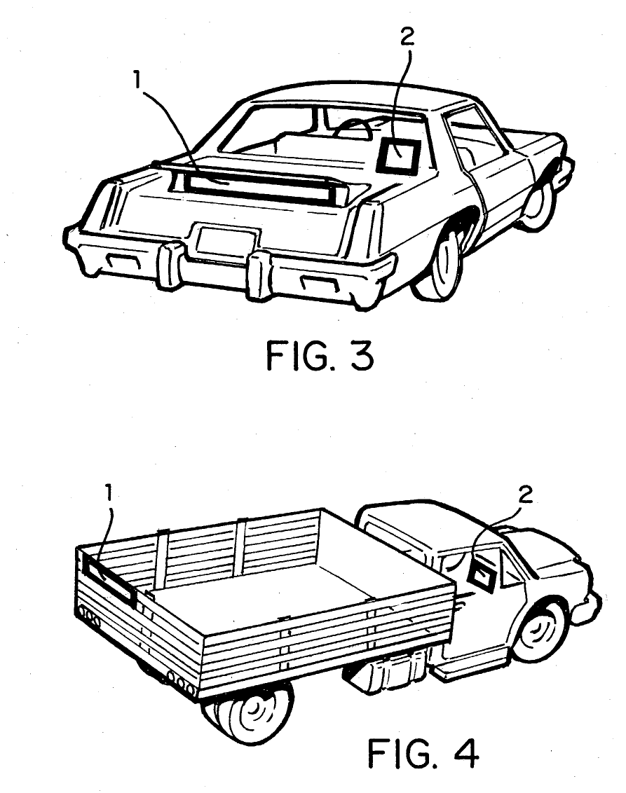

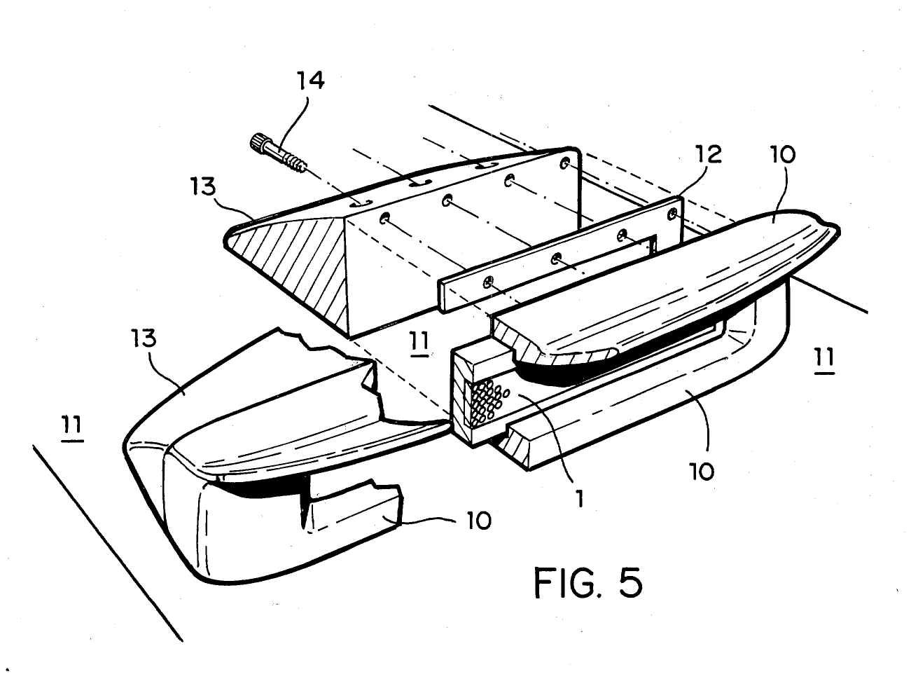

FIG. 3 illustrates the use of the display unit as it is mounted to a spoiler on the trunk of a vehicle. Details of this mounting will be explained in detail by having reference to FIG. 5.

FIG. 4 shows the invention mounted on the back of a stake truck. As can be seen, the display unit is mounted on the rear end of the stake truck so that it is visible to a driver following the truck. Again, the sending unit 2 is mounted in the cab of the truck and is readily available to the driver up front.

FIG. 5 shows the display unit 1 mounted on a spoiler 12 on the trunk lid 11 of a vehicle. The spoiler is designated as 12 and it encloses the display unit 1 by surrounding the same and as it is dictated by the opening in the spoiler 10. The spoiler 10 is mounted on the trunk lid 11 and includes a frame 12 which is backed up by a back-up frame 13. The back-up frame is an aid to enhance the wind stream of the moving vehicle in its forward motion. The back-up frame 13 is mounted by way of the bolts 14 to the rear of the spoiler 10.

The display unit 1 does not have to be displayed on or within a spoiler on a vehicle but could instead be displayed on a trunk of a vehicle by way of suction cups or magnets attached to the display unit. In this manner, the display unit can be moved from one vehicle to another.

What I claim is:

1. A changeable electronic message display unit mounted at a rear of a vehicle, said message display unit is operated by a message sending unit located in a cab of said vehicle close to the driver of said vehicle.

2. The changeable electronic message unit of claim 1, wherein said message unit is mounted on a trunk of said vehicle

3. The changeable electronic message unit of claim 2 including magnets for mounted said message unit on said trunk.

4. The changeable electronic message unit of claim 2 including suction cups for mounting said message unit on said trunk.

5. The changeable electronic message unit of claim 1, wherein said message unit is mounted on a truck.

6. The changeable electronic message unit of claim 2, wherein said message unit is installed in a spoiler mounted on said trunk of said vehicle.
